(19) United States
(12) Patent Application Publication
(10) Pub. No.: US 2003/0070129 A1
(43) Pub. Date: Apr. 10, 2003

(54) Method for packet-oriented data transmission in a radio communication system

(76) Inventors: Carsten Ball, Muenchen (DE); Arnulf Deinzer, Kempten (DE)

Correspondence Address: MORRISON & FOERSTER LLP, 1650 TYSONS BOULEVARD, SUITE 300, MCLEAN, VA, 22102, US

(21) Appl. No.: 10/149,225

(22) PCT Filed: Dec. 7, 2000
(86) PCT No.: PCT/DE00/04364

(30) Foreign Application Priority Data
Dec. 8, 1999 (DE) 199 59 160.1

(51) Int. Cl. H04J 3/24; H04L 1/18; G08C 25/02

(52) U.S. Cl. 714/748

(57) ABSTRACT

The invention relates to a method for the packet-oriented data transmission in a radio communication system. According to the inventive method, data to be transmitted are split into data blocks, encoded, transmitted via a radio interface and decoded. Transmission attempts that might have failed are recognized during decoding. An information (RSM) that characterizes a repeated data block transmission and/or information (AMB) that characterizes a first transmission mode or a second transmission mode are entered in a data block before said data block is transmitted via the radio interface.

Radio communications systems allow not only connection-oriented data transmission, which is primarily intended for the transmission of voice information, but also packet-oriented data transmission, whose scope of application is predominantly for the transmission of data information. By way of example, packet-oriented services are provided in GSM mobile radio systems by means of GPRS (General Packet Radio Services). GPRS theoretically permits a data transfer rate of 182 kb/s. In practice, the data transfer rate is only approximately 150 to 170 kb/s, however.

Third-generation mobile radio systems require a larger amount of bandwidth, particularly for multimedia applications, however. EDGE (Enhanced Data Rates For GSM Evolution) is an evolutionary further development of GSM and affords the opportunity for the higher data rates demanded to be implemented by introducing a new modulation method. EDGE makes data transfer rates of approximately 384 kb/s possible. EDGE comprises the components EGPRS (Enhanced General Packet Radio Services) for packet-oriented services and ECSD (Enhanced Circuit Switched Connections) for connection-oriented services. EDGE has been standardized by the ETSI (European Telecommunications Standards Institute) and is provided for the frequency bands 900 mHz, 1800 mHz, 1900 mHz, 850 mHz and 450 mHz. This means that EDGE can be used in all GSM frequency bands without licensing problems for existing GSM mobile radio network operators. With link adaptation and incremental redundancy, the ETSI EDGE standard provides two methods for more efficient use of the radio interface. link adaptation provides for a modulation and coding scheme to be matched to the transmission conditions measured on the radio interface. The modulation and coding scheme stipulates, among other things, modulation method, data transfer rate and code rate. Possible modulation methods are GMSK (Gaussian Minimum Shift Keying), customary for GSM, and the more powerful 8PSK (Phase Shift Keying). 8PSK is a linear modulation method in which three consecutive bits are mapped onto one symbol, which results in eight different symbol types. If transmission of a data block fails, this data block is rejected in line with link adaptation, and retransmission using an altered modulation and coding scheme is requested.

When incremental redundancy is used, data blocks received during a failed transmission attempt are stored. If successful decoding is not possible when data blocks stored during earlier failed transmission attempts are added, then a repeat transmission for the data block is requested. The repeat transmission of a data block is effected while retaining the modulation and coding scheme. By contrast, the convolutional coding for a data block which is to be sent as a repeat is performed using an altered puncturing scheme.

EP 0 418 866 A2 discloses a method for packet-oriented data transmission in a radio communications system, in which data to be transmitted are divided into data blocks, are coded, are transmitted via a radio cut and are decoded. Any failed transmission attempts are recognized during the decoding. Retransmission of a data block sent during a failed transmission attempt for a data block is requested. An erroneous data block received during a failed transmission attempt for a data block is collected in a memory. A data block to be sent is always provided with a block sequence number identifying the order of the data block within a data packet. This block sequence number is used to identify a data block so that its block sequence number can be used to request retransmission of said data block specifically in the event of a transmission error.

The invention is based on the object of specifying a method for packet-oriented data transmission at high data rates which allows efficient utilization of storage and processing capacity available in a radio communications system.

The invention achieves this object by means of a method having the features cited in claim 1. Advantageous developments of the inventive method can be found in claims 2 to 13.

With the inventive method, in the case of a repeat data block transmission, an information item identifying the repeat transmission is entered into the data block which is to be resent before this data block is transmitted via the radio interface. In addition, retransmission of a data block sent during a failed transmission attempt is requested. A data block received during a failed transmission attempt is collected in a memory at the receiver end.

A fundamental aspect of the inventive method can be seen in that, when a data block is transmitted for the first time, there is no need to search the memory for data blocks collected during earlier failed transmission attempts. The memory may need to be searched, by way of example, during error elimination or when the memory is updated. It is also generally the case that a data block can be decoded successfully upon the very first transmission attempt. By contrast, searching the memory in order to recognize a data block sent as a repeat again is always time-consuming and ties up storage and processing capacity, which is thus not available for other processes.

Preferably, an information item identifying a first or second transmission mode is entered into a data block before this data block is transmitted via the radio interface. If an information item identifying the first transmission mode is recognized, retransmission of a data block sent during a failed transmission attempt is requested. In addition, this data block is collected in a memory at the receiver end. If an information item identifying the second transmission mode is recognized, a data block received during a failed transmission attempt is rejected. A fundamental aspect of this development can be seen in that, in the absence of the information item identifying a transmission mode, data blocks received during a failed transmission attempt would be stored entirely unnecessarily at the receiver end in the second transmission mode as well, which ties up storage and processing capacity.

In line with another advantageous development of the inventive method, a data block to be transmitted is provided with a header (data header) into which the information item identifying a repeat transmission or the information item identifying a transmission mode is entered. In line with another advantageous development of the inventive method, a particularly simple implementation can be achieved if a respective spare bit of a GPRS uplink header (Enhanced General Packet Radio Services) is used for entering the corresponding information.

In line with another advantageous refinement of the inventive method, the data to be transmitted are subjected to convolutional coding using a puncturing method. In the case of a repeat data block transmission, this puncturing method is carried out using an altered puncturing scheme. This affords the advantage that the data blocks transmitted during different transmission attempts have redundancy added to them or removed from them at respectively different points. For decoding with the addition of the data blocks stored during earlier failed transmission attempts, this affords the advantage that there is very little likelihood of a transmission error occurring at precisely the same point within a plurality of data blocks.

The invention is explained in more detail below using exemplary embodiments with reference to the drawing, in which

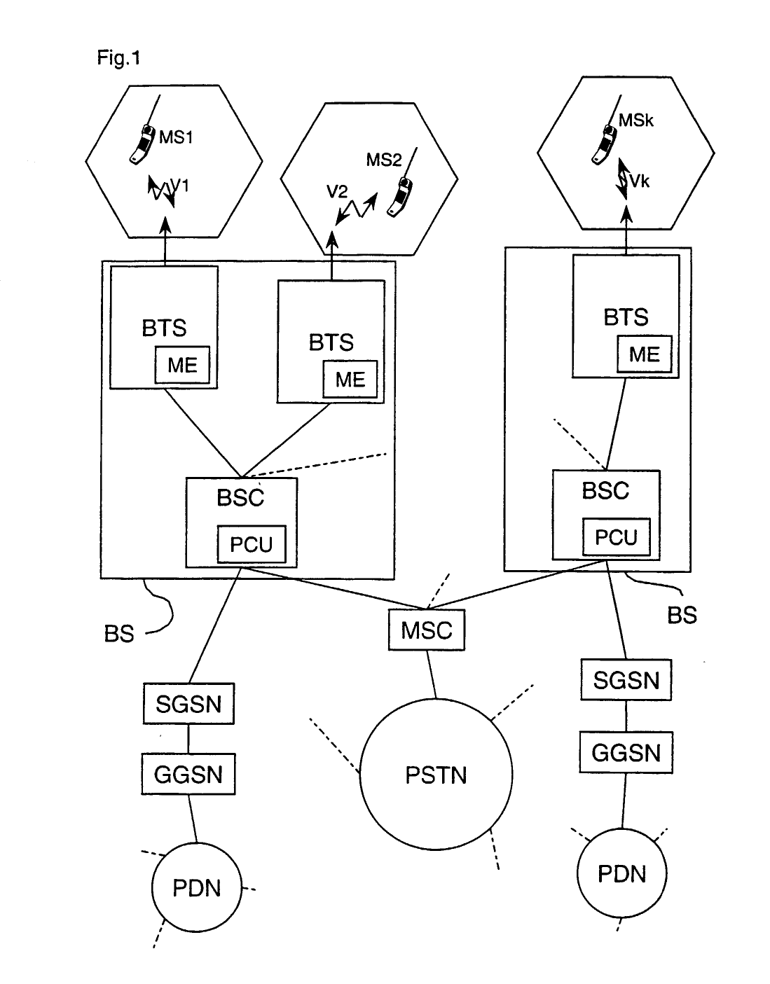

FIG. 1 shows a block diagram of a radio communications system,

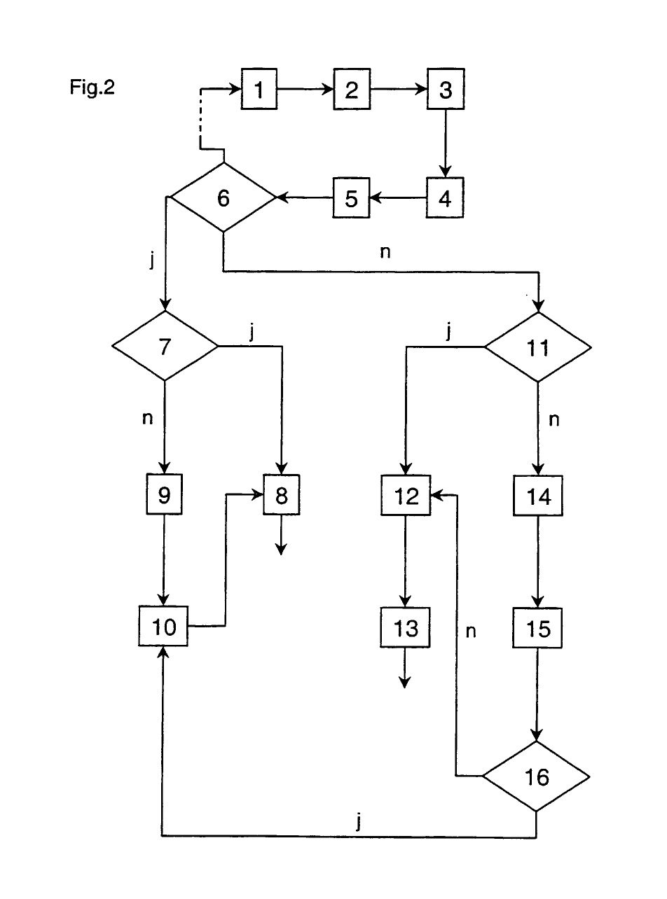

FIG. 2 shows a flowchart to illustrate the way in which the inventive method works,

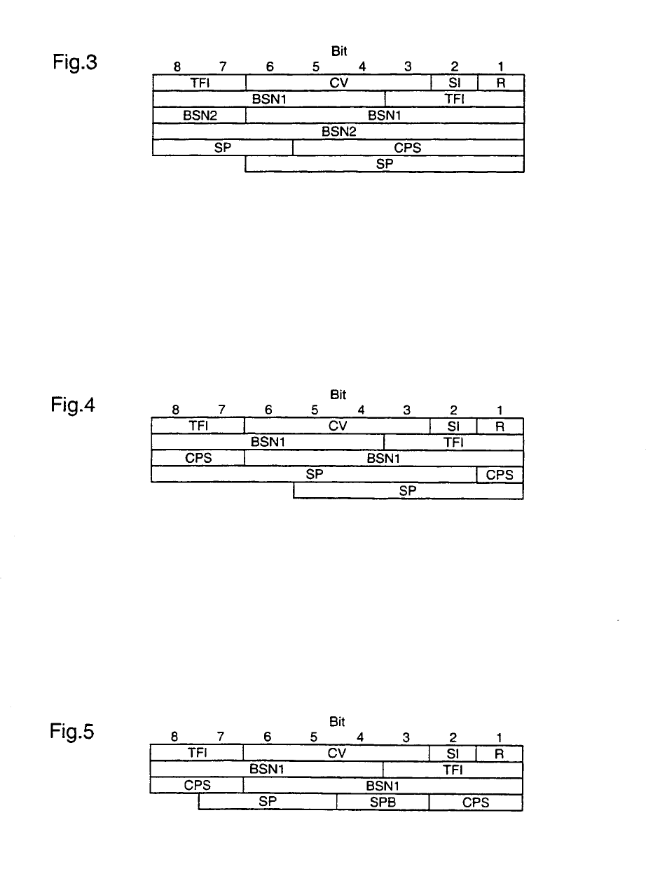

FIG. 3 shows a first type of EGPRS uplink header based on the prior art,

FIG. 4 shows a second type of EGPRS uplink header based on the prior art,

FIG. 5 shows a third type of EGPRS uplink header based on the prior art,

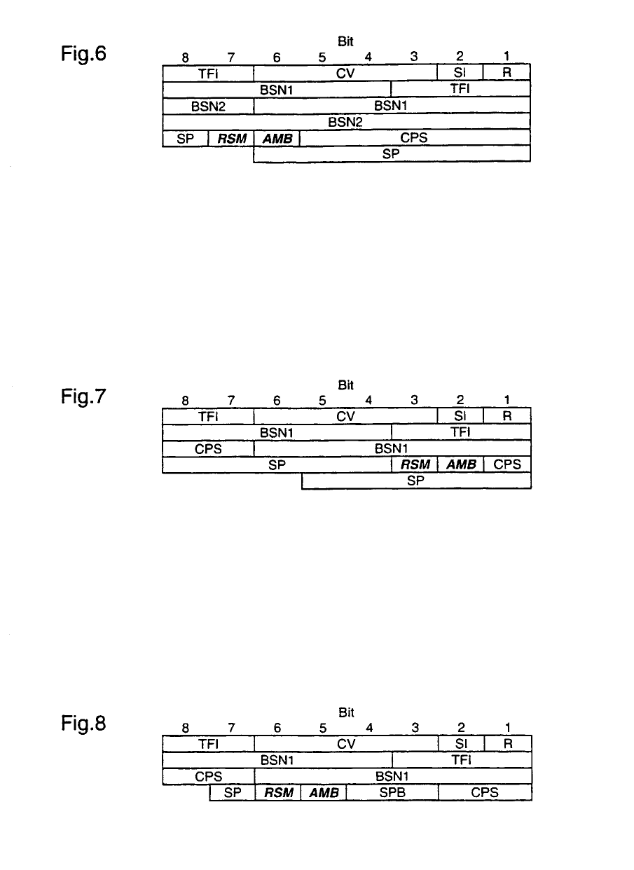

FIG. 6 shows a first type of EGPRS uplink header in modified form,

FIG. 7 shows a second type of EGPRS uplink header in modified form, and

FIG. 8 shows a third type of EGPRS uplink header in modified form.

The structure of the radio communications system shown in FIG. 1 corresponds to that of a known GSM mobile radio network having a multiplicity of mobile switching centers MSC for connection-oriented services which are interconnected and permit access to a landline network PSTN. In addition, the mobile switching centers MSC are at least connected to a base station controller BSC.

Each base station controller BSC permits connection to at least one base transceiver station BTS. Base station controller BSC and associated base transceiver stations BTS are combined to form a base station subsystem BS. Such a base transceiver station BTS can use a radio interface to set up a voice or data link to subscriber stations MS1, MS2, MSk.

An evolutionary further development of GSM is EDGE (Enhanced Data Rates for GSM Evolution). EDGE permits data rates of 384 kb/s, whereas GSM affords a maximum data transfer rate of 182 kb/s. EDGE has the components EGPRS (Enhanced General Packet Radio Services) for packet-oriented services and ECSD (Enhanced Circuit Switched Connections) for connection-oriented services. For packet-oriented services, provision is made for the base station controller BSC to be coupled to a packet data network PDN via a router SGSN (Serving GPRS Support Node) and a gateway GGSN (Gateway GPRS Support Node).

FIG. 1 shows, by way of example, connections V1, V2 and Vk for transmitting user and signalling information between mobile stations MS1, MS2, MSk and a base transceiver station BTS. An operation and maintenance center (not shown in more detail) performs control and maintenance functions for prescribable regions within the mobile radio network. The functionality of this structure can, in principle, also be transferred to other radio communications systems in which the invention can be used, particularly for subscriber access networks with wireless subscriber access.

The flowchart shown in FIG. 2 illustrates the way in which the inventive method for packet-oriented data transmission works. For the considerations below, it is assumed that data to be transmitted are sent by a subscriber station MS1, MS2, MSk and are received by a base transceiver station BTS. Data to be transmitted are first divided into data blocks (step 1) and are then preferably subjected to convolutional coding using a puncturing method (step 2).

If a repeat data block transmission is made, then, in line with the inventive method, in the next step, an information item identifying a repeat transmission is entered, at the transmitter end, into the data block which is to be transmitted as a repeat (step 3). In line with one advantageous development of the inventive method, an information item identifying a transmission mode is entered, at the transmitter end, into the data block which is to be transmitted (step 3). This information item can be entered into the data block to be transmitted together with the information item identifying a repeat transmission. Preferably, the corresponding information items are entered into a header in the data block in question.

Next, the coded data block is transmitted via the radio interface (step 4) and is decoded at the receiver end (step 5). A check is then carried out to determine whether the received data block has been decoded successfully (step 6).

If decoding was unsuccessful, then the transmission attempt is deemed to have failed. If, in addition, an information item identifying a second transmission mode is recognized, the received data block is rejected and retransmission of the nondecodable data block is requested. This is indicated in FIG. 2 by the dashed line linking step 6 to step 1. The repeat data block transmission is controlled, by way of example, by an ARQ protocol (Automatic Repeat Request), the associated functions being implemented at the receiver end by a control device PCU (Packet Control Unit) associated with a base station controller BSC (see FIG. 1). For a repeat data block transmission, the puncturing method is advantageously carried out using an altered puncturing scheme, which means that the points at which redundancy symbols are inserted within a coded data block are varied. The puncturing scheme can be altered cyclically, for example.

If, on the other hand, the decoding in line with step 5 was successful recognized, and also an information item identifying a first transmission mode is recognized, then a check is carried out to determine whether the received data block contains an information item identifying a repeat transmission (step 7). If there is no information item identifying a repeat transmission, the data block transmission is terminated (step 8). If, on the other hand, the information item entered into the data block identifies a repeat transmission, then a memory ME collecting data blocks received during failed transmission attempts is searched for data blocks stored during earlier failed transmission attempts (step 9). The memory ME is preferably associated with a base transceiver station BTS (see FIG. 1). The data blocks found are then erased (step 10), since decoding has already been successful and these data blocks are therefore no longer required for joint decoding (Joined Decoding). Finally, the data block transmission is ended (step 8).

If the decoding in line with step 5 was not successful and also if an information item identifying the first transmission mode is recognized, then a check is carried out to determine whether the received data block contains an information item identifying a repeat transmission (step 11). If the data block has been transmitted for the first time, the data block is stored for later error elimination (step 12). Next, a repeat transmission for the corresponding data block using an altered puncturing scheme is requested (step 13). If the data block has been transmitted as a repeat, on the other hand, then the memory ME is searched, for the purposes of error elimination, for data blocks stored during earlier failed transmission attempts (step 14). Next, a decoding attempt is started, in which, besides the last data block received, the data blocks stored during earlier failed transmission attempts are also included (step 15). A check is then carried out to determine whether this decoding attempt was successful (step 16). If the decoding attempt was successful, the data blocks stored during earlier failed transmission attempts are erased (step 10) and the data block transmission is terminated (step 8). If the decoding in line with step 15 was unsuccessful, however, then the last data block received is likewise stored (step 12) and renewed data block transmission is requested (step 13).

The second transmission mode, in which erroneous data blocks are rejected and are requested again, is intended primarily for transmitting data containing voice or picture information using a packet-oriented service. A repeat data transmission would be a problem in this case, since this would result in undesirable delays and echoes. In addition, powerful mechanisms are available for interpolating missing data if appropriate.

In imitation of the incremental redundancy method described in the ETSI EDGE standard, a data block to be transmitted as a repeat is preferably transmitted while retaining a modulation and coding scheme. The modulation and coding scheme prescribes modulation method, code rate and data rate.

The information item identifying a repeat transmission or the information item identifying a transmission mode is preferably entered into a data block by a subscriber station during an uplink. The problem of an unavailable information item relating to a repeat data block transmission or of an unknown transmission mode can be circumvented for the downlink by suitable hardware architecture, where the control unit for implementing the ARQ protocol and the memory for the nondecodable data blocks are coupled to one another directly on a physical level.

With respect to the uplink, the structure of such a hardware architecture is much more complex, on the other hand, since the memory ME for the nondecodable data blocks is associated with a base transceiver station BTS, while the control device PCU for implementing the ARQ protocol is normally arranged in a base station controller BSC. In this case, the control device PCU and the memory ME are physically separate from one another. In order to make the least possible use of transmission capacities which are available on the interface between the base transceiver station BTS and the base station controller BSC, direct coupling on a physical level between the control device PCU and the memory ME is dispensed with. In addition, cost considerations are in favor of the control device PCU not being arranged locally to each base transceiver station BTS, but rather just in one base station controller BSC. In addition, it is not a simple matter to change defined hardware architectures, particularly in a mobile radio system, since this involves taking into account a large number of interactions between individual system components.

Data blocks transmitted in the uplink are thus preferably decoded within a base transceiver station BTS. The same applies to the evaluation of the information item identifying a repeat transmission or a transmission mode. A data block received during a failed transmission attempt is likewise preferably stored or rejected within the base transceiver station BTS.

In imitation of the link adaptation method known from the ETSI EDGE standard, lack of capacity in the memory ME means that a data block received during a failed transmission attempt is rejected, with a repeat data block transmission being effected while varying the modulation and coding scheme. The modulation and coding scheme prescribes modulation method, code rate and data rate. The data block to be transmitted as a repeat is expediently transmitted while retaining the puncturing scheme, since no provision is made for storing nondecodable data blocks with the aim of later joint decoding.

In line with one particularly preferred embodiment, both the information item identifying a repeat transmission and the information item identifying a transmission mode are respectively entered into a spare bit of an EGPRS uplink header. The EGPRS uplink headers shown in FIGS. 3 to 5 are specified by the ETSI GSM standard 04.60 version 8.0.0. The different header types are assigned in line with the modulation and coding schemes used for transmission, which are summarized in the table below.

| Modulation and | | Modulation | Maximum data |
|---|---|---|---|
| coding scheme | Code rate | method | rate [kb/s] |
| MCS-9 | 1.0 | 8PSK | 59.2 |
| MCS-8 | 0.92 | | 54.4 |
| MCS-7 | 0.76 | | 44.8 |
| MCS-6 | 0.49 | | 29.6 |
| MCS-5 | 0.37 | | 22.4 |
| MCS-4 | 1.0 | GMSK | 17.6 |
| MCS-3 | 0.80 | | 14.8 |
| MCS-2 | 0.66 | | 11.2 |
| MCS-1 | 0.53 | | 8.8 |

A first type (shown in FIG. 3) of EGPRS uplink header is provided for modulation and coding schemes MCS-7, MCS-8 and MCS-9. FIG. 4 shows a second type of EGPRS uplink header used in connection with the modulation and coding scheme MCS-5 or MCS-6. For the modulation and coding schemes MCS-1, MCS-2, MCS-3 and MCS-4, a third type (shown in FIG. 5) of EGPRS uplink header is used. The headers shown in FIG. 3 to FIG. 5 contain a retry bit R, a stall indicator bit SI, a countdown value field CV, a temporary flow identifier field TFI, a block sequence number field BSN and a coding and puncturing scheme indicator field CPS. In addition, each of the EGPRS uplink headers shown in FIG. 3 to FIG. 5 have a plurality of available spare bits SP. The precise meanings of said bits and fields can be found in ETSI GSM standard 04.60 version 8.0.0.

The temporary flow identifier field TFI is used for identifying a data stream sent to a particular subscriber station, and thus allows a data stream to be associated with a subscriber station. The block sequence number field BSN contains a number for a data block within a data stream. If the headers or data blocks contain no information identifying a repeat data block transmission, then the memory ME needs to be searched for temporary flow identifier values and block sequence number values in order to check whether or not a received data block was sent as a repeat. However, this procedure requires a comparatively large amount of time and results in unnecessary use of system resources.

FIGS. 6 to 8 show EGPRS uplink headers in modified form, where a respective spare bit is used up for transmitting the information item identifying a repeat transmission and the information item identifying a transmission mode. The EGPRS uplink header shown in FIG. 6 is intended for the modulation and coding schemes MCS-7, MCS-8 and MCS-9, while the EGPRS uplink header shown in FIG. 7 is used in connection with the modulation and coding schemes MCS-5 and MCS-6. The EGPRS uplink header shown in FIG. 8 is intended for the modulation and coding schemes MCS-1, MCS-2, MCS-3 and MCS-4. FIGS. 6 to 8 respectively show a first newly introduced bit RSM (Retransmission with Same Modulation and coding scheme), which contains the information item identifying a repeat transmission. A second newly introduced bit AMB (Acknowledge Mode Bit) contains the information item identifying a transmission mode. As FIGS. 6 to 8 clearly show, said information items can very easily be entered into existing headers.

1. A method for packet-oriented data transmission in a radio communications system, in which
data to be transmitted are divided into data blocks, are coded, are transmitted via a radio interface and are decoded,
any failed transmission attempts are recognized during the decoding,
retransmission of a data block sent during a failed transmission attempt is requested,
an erroneous data block received during a failed transmission attempt is collected in a memory (ME),
characterized in that
in the case of a repeat data block transmission, an information item (RSM) identifying the repeat transmission is entered into the data block which is to be resent before this data block is transmitted via the radio interface,
just in the case of a received data block containing an information item (RSM) identifying a repeat transmission, the memory (ME) is searched for erroneous data blocks collected during earlier failed transmission attempts, for the purposes of error elimination.

2. The method as claimed in claim 1,
characterized in that
an information item (AMB) identifying a first transmission mode or a second transmission mode is entered into a data block before this data block is transmitted via the radio interface,
this information item (AMB) is evaluated in the event of a failed transmission attempt, and in that, just if an information item identifying the first transmission mode is recognized,
retransmission of the data block sent during a failed transmission attempt is requested,
the data block received during a failed transmission attempt is collected in the memory (ME),
in the case of a repeat data block transmission, an information item (RSM) identifying the repeat transmission is entered into the data block which is to be resent before this data block is transmitted via the radio interface,
just in the case of a received data block containing an information item (RSM) identifying a repeat transmission, the memory (ME) is searched for data blocks collected during earlier failed transmission attempts, for the purposes of error elimination,
and in that, if an information item identifying the second transmission mode is recognized, a data block received during a failed transmission attempt is rejected.

3. The method as claimed in one of claims 1 to 2, characterized in that a data block to be transmitted is provided with a header, and in that the information item (RSM) identifying a repeat transmission and/or the information item (AMB) identifying a transmission mode are/is entered into the header.

4. The method as claimed in one of claims 1 to 3, characterized in that the data to be transmitted are subjected to convolutional coding using a puncturing method, and in that, in the case of a repeat data block transmission, the puncturing method is carried out using an altered puncturing scheme.

5. The method as claimed in claim 4,
characterized in that the puncturing scheme is varied cyclically.

6. The method as claimed in one of claims 1 to 5, characterized in that a data block to be sent as a repeat is transmitted while retaining a modulation and coding scheme, the modulation and coding scheme prescribing modulation method, coding rate and data rate.

7. The method as claimed in one of claims 1 to 6, characterized in that the information item (RSM) identifying a repeat transmission and/or the information item (AMB) identifying a transmission mode are/is entered into a data block by a subscriber station (MS1, MS2, MSk) during an uplink.

8. The method as claimed in claim 7,
characterized in that a received and/or stored data block are/is decoded within a base transceiver station (BTS).

9. The method as claimed in one of claims 7 or 8, characterized in that the information item (RSM) identifying a repeat transmission and/or the information item (AMB) identifying a transmission mode are/is evaluated within a base transceiver station (BTS).

10. The method as claimed in one of claims 7 to 9, characterized in that a data block received during a failed transmission attempt is stored or rejected within a base transceiver station (BTS).

11. The method as claimed in one of claims 1 to 10, characterized in that the information item (RSM) identifying a repeat transmission and/or the information item (AMB) identifying a transmission mode are/is respectively entered into a spare bit of an Enhanced General Packet Radio Services uplink header (EGPRS header).

12. The method as claimed in one of claims 1 to 11, characterized in that, if the memory (ME) has insufficient capacity,
a data block received during a failed transmission attempt is rejected,
in the case of a failed data transmission, a repeat data transmission is effected while varying a modulation and coding scheme, the modulation and coding scheme prescribing modulation method, code rate and data rate.

13. The method as claimed in claim 12,
characterized in that, if the memory (ME) has insufficient capacity, a data block to be sent as a repeat is transmitted while retaining the puncturing scheme.
